(19) United States
(12) Patent Application Publication
(10) Pub. No.: US 2008/0066314 A1
(43) Pub. Date: Mar. 20, 2008

(54) Clipping Device

(75) Inventor: Bettina Rapold, Klagenfurt (AT)

Correspondence Address: PHILIPS ELECTRONICS NORTH AMERICA CORPORATION;INTELLECTUAL PROPERTY & STANDARDS, 370 W. TRIMBLE ROAD MS 91/MG, SAN JOSE, CA, 95131, US

(73) Assignee: KONINKLIJKE PHILIPS ELECTRONICS N.V., Eindhoven (NL)

(21) Appl. No.: 11/629,605

(22) PCT Filed: Jun. 3, 2005
(86) PCT No.: PCT/IB05/51816

§ 371 Date: Dec. 13, 2006

(30) Foreign Application Priority Data
Jun. 14, 2004 (EP) 04102695.6

(51) Int. Cl. B26B 19/20

(52) U.S. Cl. 30/30

(57) ABSTRACT

To avoid miscuts and injuries on strongly curved, bumpy and/or moving surfaces and improve the ease of use of the clipping device (1), it has been suggested to provide a clipping device (1) with a cutting unit (3) and a comb unit (4) that are arranged to be simultaneously movable with respect to the casing (2) while the distance (D) between the cutting unit (3) and the comb unit (4) is kept constant. Preferably, the cutting unit (3) and the comb unit (4) are connected to the casing (2) via an elastic element (5).

The invention relates to a clipping device as used for cutting hair, trimming beards or trimming animals.

Clipping devices are widely used for cutting hair, especially for short haircuts and around the ears or for trimming beards. Dogs, e.g. poodles or other animals may be trimmed, too with the help of a clipping device.

Generally used clipping devices have a cutting unit with two blades moved relatively to one another with help of a motor. The cutting device is normally mounted on a casing housing the motor or batteries as power supply for the clipping device. To define a certain cut length and to make the hair stand upright for cutting, a comb unit is mounted on the casing covering the cutting unit. The actual cutting length is normally defined by the length of the comb unit's teeth. The hair length is equivalent to the distance of the blades to the skin whereon the comb unit fixed on the casing is applied for cutting. To enlarge the range of usability of the clipping device, either different comb units having teeth with various lengths or comb units movable with respect to the cutting unit are provided to allow for haircuts of different lengths.

U.S. Pat. No. 6,260,276 describes a hair clipping machine with a device for adjusting the length of the cut, with the adjusting device acting upon the clipping assembly. The clipping assembly includes at least a fixed clipping comb and a clipping blade, which can be driven in an oscillatory motion essentially parallel to the front edge of the clipping comb. The adjusting device includes at least an actuating element that is connected to the clipping blade via coupling elements for displacing the clipping blade lengthwise to adjust the cutting length. The cuffing blade is connected to a spring element, so that the clipping blade is continuously biased against the clipping comb and supported with a parallelogram-type guide arrangement.

The part of the body, where hair is to be cut, such as the head, is generally curved and bumpy. To maintain a constant cut length, it is necessary that the clipping device stays continuously in contact with the skin. The user has to press the clipping device continuously against the skin, sometimes with lesser force, sometimes with quite strong a force. The strong pressure applied to the skin is not only uncomfortable to the living being getting its hair cut, but it also heightens the friction on the skin. In extreme cases, the clipping device can even get stuck or injure the skin. This problem is especially serious, when cutting the hair of very young children up to an age of around four years. On the one hand, they still have a very sensitive skin and the curvature radius of their head is quite small. On the other hand, they tend to move a lot, whilst getting their hair cut, making it quite difficult to press the clipping device evenly against the skin.

It is an object of the invention to provide clipping devices that have a reduced risk of injuring the living being getting its hair cut.

In a first aspect, the invention provides a clipping device comprising a casing, a cutting unit to be mounted on the casing and a comb unit to be mounted on the casing and/or the cutting unit, wherein the cutting unit and the comb unit are arranged to be simultaneously movable with respect to the casing while the distance between the cutting unit and the comb unit is kept substantially constant. Substantially constant is to be understood in a way that differences in the distance are kept so small that they do not negatively influence the hair cut length. Thus, if to strong a pressure is applied to the skin, the comb unit recedes and reduces the pressure acting on the skin. But because the cutting unit recedes simultaneously and the distance between the comb unit and the cutting unit is kept constant while moving, the cut length stays the same in spite of the movement of the comb unit. Advantageously, a constant contact of the clipping device is allowed for, enhancing the quality of the hair cut and the convenience or ease of use for the user.

Preferably, the cutting unit and the comb unit are arranged to be slideable in a direction longitudinal with the casing and/or are connected with the casing via an elastic element to enhance the effect of compensating pressures applied to the skin that are too strong.

In a preferred embodiment, the clipping device has a drive unit for driving the cutting unit. At least a part of the drive unit is arranged to be simultaneously movable with the cutting unit and the comb unit. In case of the cutting unit and the comb unit being connected to the casing via an elastic element, the movable part of the drive unit is preferably connected to the casing via that elastic element, too.

Preferably, the comb unit comprises a comb body and a guidance part to be mounted on the casing and/or cutting unit, the comb body and the guidance part being movable with respect to the cutting unit for changing the cut length.

A preferred embodiment of the present invention is described herein with reference to the drawings wherein:

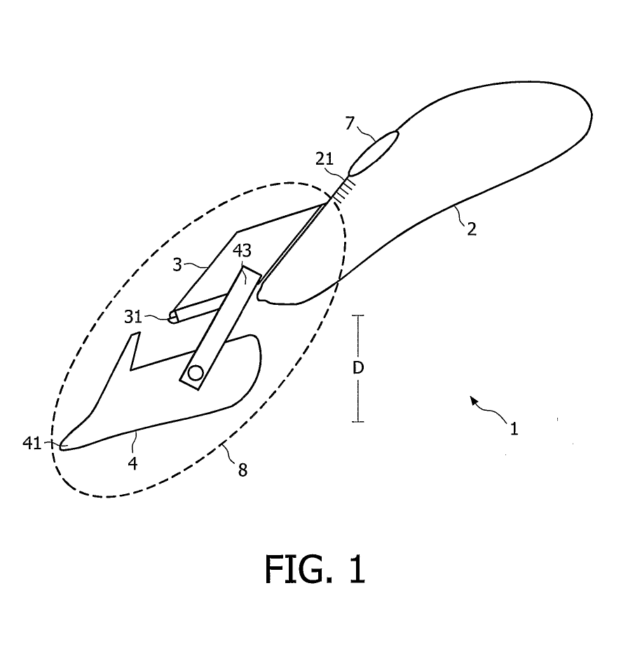

FIG. 1 shows an embodiment of the clipping device according to the invention in a position corresponding to low pressure;

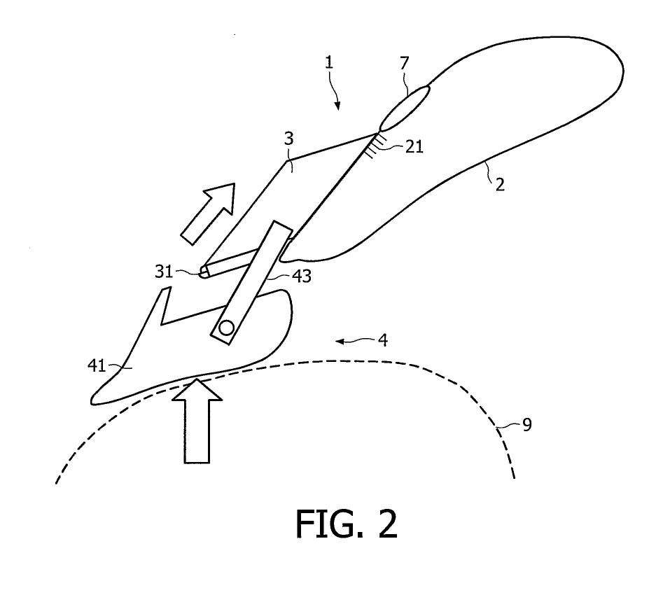

FIG. 2 shows the embodiment of FIG. 1 in a position corresponding to strong pressure;

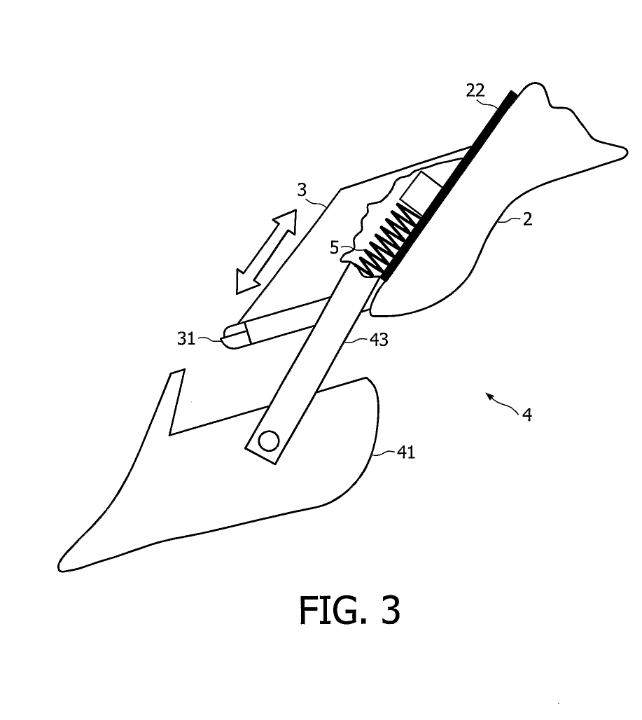

FIG. 3 shows an enlargement of the embodiment of FIG. 1 illustrating the connection mechanism between casing and cutting unit with comb unit;

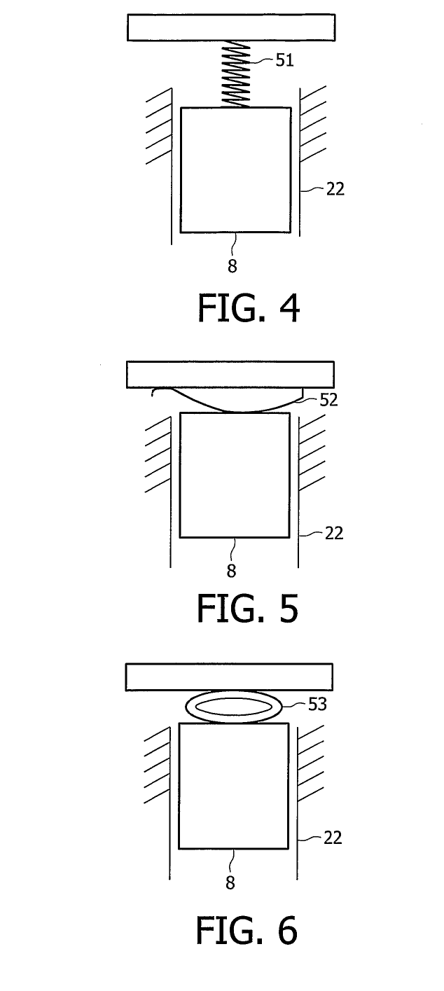

FIG. 4 shows a first example of an elastic element;

FIG. 5 shows a second example of an elastic element;

FIG. 6 shows a third example of an elastic element;

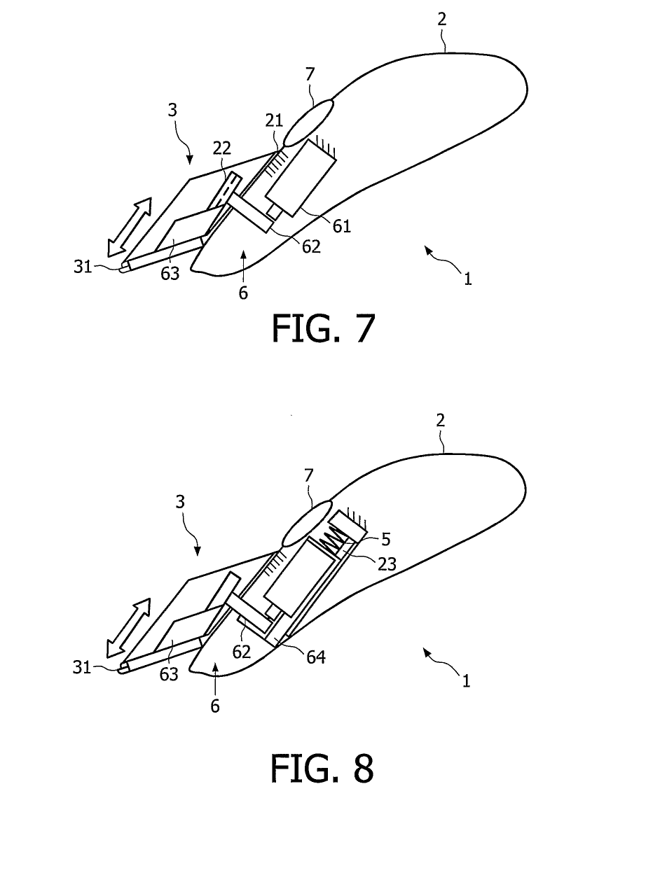

FIG. 7 shows a first embodiment with drive unit according to the invention;

FIG. 8 shows a second embodiment with drive unit according to the invention;

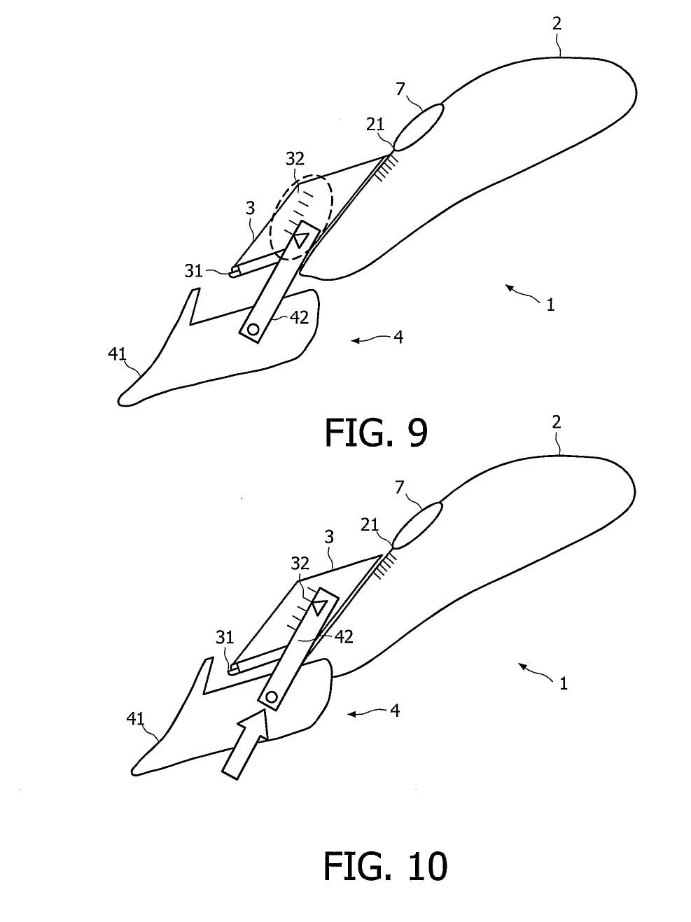

FIG. 9 shows an embodiment with adjustable comb unit in a first position and

FIG. 10 shows the embodiment of FIG. 9 in a second position.

FIG. 1 shows a clipping device 1 having a casing 2, a cutting unit 3 and a comb unit 4. The clipping device 1 is switched on and off with help of the switch 7. The comb unit 4 includes a comb body 41 and a mounting arm 43 for mounting the comb unit 4 on the cutting unit 3. It is to be understood that the comb unit 4 could be mounted on the casing 2 as well. The cutting unit 3 includes blades 31. Most clipping devices function with two blades that are moved longitudinally with respect to each other. The cut length is defined by the distance D between the blades 31 and the lower part of the comb body 41 touching the skin while hair is cut.

The cutting unit 3 and the comb unit 4 form together a movable unit 8 that can be moved with respect to the casing 2. The position of the movable unit 8 with respect to the casing 2 may be indicated by a scale 21 on the casing 2. When moving movable unit 8 with respect to the casing 2, the distance D between the cutting unit 3 and the comb unit 4 defining the cut length is kept constant. This concept is made clearer by comparing FIG. 1 and FIG. 2.

In FIG. 2, the clipping device 1 is shown while cutting hair on the head 9 of a little child. The child is moving its head 9 upward (see arrow near head 9). This leads to a sudden increase in pressure acting form the comb body 41 on the head's skin. But in moving the cutting unit 3 and the comb unit 4 together in a direction longitudinal with the casing 2 (see arrow next to cutting unit 3), this sudden increase in pressure is compensated and the cut length does not deviate form the expected cut length. This is achieved, because the cutting unit 3 and the comb unit 4 are moved simultaneously without changing their respective distance D.

The different positions of the cutting unit 3 and the comb unit 4 with respect to the casing 2 are made more visible by the scale 21 on the casing 2. In FIG. 1, the movable unit 8 of cutting unit 3 and comb unit 4 is in a position equivalent to the bottommost bar of the scale gradation, and in FIG. 2 in a position equivalent to the uppermost bar of the scale gradation.

In preferred embodiments, the cutting unit 3 and the comb unit 4 on the one hand and the casing 2 on the other hand are connected via an elastic element 5, as illustrated in FIG. 3. In the particular case shown in FIG. 3, the comb unit 4 is mounted on the cutting unit 3 and the cutting unit 3 is actually connected with the casing 2 via the elastic element 5. It would be possible as well, for example, to have both the cutting unit 3 and the comb unit 4 connected with the casing 2 via an elastic element 5 each.

With the help of an elastic element 5, not only pressure increases are compensated in a defined pressure range, being defined by the elasticity modulus of the elastic element 5. Because of the resiliency of the elastic element 5, the cutting unit 3 and the comb unit 4 move back into the position before the pressure increase, away from the casing 2, when the pressure applied to the skin decreases again, thus compensating a pressure decrease, too.

In the example illustrated in FIG. 3, the elastic element 5 is combined with a mechanism making sure that the cutting unit 3 and the comb unit 4 slide in a direction longitudinal with the casing 2, when moved. To achieve this, the cutting unit 3 and the comb unit 4 are seated in a guidance rail 22 in which they slide up and down along the casing 2, as schematically shown by the arrow. It will be understood that the guidance rail 22 or some other sliding mechanism, such as for example kinematic mechanism, e.g. a parallelogram, may be used in preferred embodiments without elastic element 5, too.

One important point of the sliding mechanism is to provide for defined direction of the movement compensating the pressure change, a direction that could be any other direction from the direction longitudinal with the casing, too, according to the particular embodiment of the clipping device. One important point of the elastic element is to provide for a defined pressure range and a defined reaction time of the compensating system.

FIGS. 4 to 6 schematically show some examples of possible elastic elements 5. The movable unit 8 is moving in a direction defined by the guidance rail 22. The range of pressure to be compensated and the reaction time is defined by the elastic elements 51, 52, 53. In FIG. 4, the elastic element is a spiral spring 51. In FIG. 5, the elastic element is a leaf spring 52. In FIG. 6, the elastic element is a piece 53 of an elastomer. It is to be understood that the person skilled in the art will know many more possible elastic elements and choose the appropriate elastic element depending on e.g. the dimensions of the clipping device, the production cost or the value of the pressure changes to be expected.

Apart from mechanical elastic elements as shown in FIGS. 4 to 6, other preferred embodiments are based on electric or pneumatic or hydraulic elastic elements. An example for an electric elastic element would be e.g. an electric sensor system measuring the pressure applied on the skin and regulating it with the help of a reset motor.

FIGS. 7 and 8 show preferred embodiment of the clipping device 1 having a drive unit 6 for driving the cutting unit 3. The comb unit 4 is not shown for the sake of clarity. The main components of the drive unit 6 illustrated in FIGS. 7 and 8 are a motor 61 housed in the casing 2, a driving element 63 housed in the cutting unit 3 and a motion converter 62 connecting the motor 61 and the driving element 63. The motor may be supplied with energy by a battery, possibly a regenerative battery, or via a wire by an external power supply.

In the example shown in FIG. 7, the driving element 63 housed in the cutting unit 3 is part of the movable unit and the motion converter 62 and the motor are fixed in the casing 2 and part of the static unit. The connection between the moving unit and the static unit is made at the guidance rail 22. The guidance rail 22 is fixed on the casing and on the one hand allowing the connection of the motion converter 62 with the driving element 63 and on the other hand allowing the cutting unit 3 with the driving element 63 and the comb unit to move along the casing 2 in order to compensate pressure changes due to curvature and/or bumpiness or unexpected movements of the part where hair is to be cut with help of the clipping device 1. In another preferred embodiment, instead of the guidance rail 22, there may be two guidance rails working together, one fixed on the cutting unit 3 and one fixed on the casing 2.

In the example shown in FIG. 8, not only the driving element 63, but also the motion converter 62 and the motor 61 are part of the movable unit. There are fixed connections between the driving element 63, the motion converter 62 and the motor 61. The motor 61 with the motions converter 62 and the driving element 63 is attached on a support element 64 that is seated on the guidance rail 23, this guidance rail 23 being part of the casing 2. The motor 61 is connected with the casing 2 via an elastic element 5 to control the movement compensating pressure changes.

It will be understood by the person skilled in the art that there are many more possibilities of integrating part of or the whole drive unit 6 into the movable unit able to move depending on the pressure acting as opposed to the static unit essentially defined by the casing 2.

In FIGS. 9 and 10, an example of a preferred embodiment with an adjustable comb unit 4 is illustrated. The adjustable comb unit 4 comprises a comb body 41 and a setting arm 42. The setting arm 42 allows mounting the comb unit 4 in different positions on the cutting unit 3. The actual position may be indicated by the scale 32 on the cutting unit 3. In FIG. 9, the position of the comb unit 4 with respect to the cutting unit 3 is equivalent to a long cut length and in FIG. 10 to a short cut length.

Another possibility of changing the cut length consists in providing various comb units of different dimensions, each defining another cut length, and exchanging them in order to change the cut length.

It is noted that the preferred embodiments of the clipping device described herein in detail for exemplary purposes are of course subject to many different variations in structure, design, application and methodology. Because many varying and different embodiments may be made within the scope of the inventive concept herein taught, and because many modifications may be made in the embodiment herein detailed, it is to be understood that the details herein are to be interpreted as illustrative and not in a limiting sense. For example, various combinations of the features of the following dependent claims could be made with the features of the independent claim without departing from the scope of the present invention. Furthermore, any reference numerals in the claims shall not be construed as limiting scope.

### LIST OF REFERENCE NUMERALS

1 clipping device
2 casing
21 scale
22 guidance rail
23 guidance rail
3 cutting unit
31 blades
32 scale
4 comb unit
41 comb body
42 setting arm
43 mounting arm
5 elastic element
51 spiral spring
52 leaf spring
53 piece of elastomer
6 drive unit
61 motor
62 motion converter
63 drive element
64 support element
7 switch
8 movable unit
9 head
D distance

1. A clipping device comprising:
a casing,
a cutting unit mounted on the casing and
a comb unit to be mounted on the casing and/or the cutting unit,
wherein the cutting unit and the comb unit are arranged to be simultaneously movable with respect to the casing while the distance between the cutting unit and the comb unit is kept substantially constant.

2. The clipping device of claim 1 wherein the cutting unit and the comb unit are arranged to be slideable in a direction longitudinal with the casing.

3. The clipping device of claim 1 wherein the cutting unit and the comb unit are connected with the casing via an elastic element.

4. The clipping device of claim 1 wherein the cutting unit and the comb unit are arranged to be slideable in a direction longitudinal with the casing and are connected with the casing via an elastic elements.

5. The clipping device of claim 1 having a drive unit for driving the cutting unit wherein at least a part of the drive unit is arranged to be simultaneously movable with the cutting unit and the comb unit.

6. The clipping device of claim 3 having a drive unit for driving the cutting unit wherein at least a part of the drive unit is arranged to be simultaneously movable with the cutting unit and the comb unit and connected with the casing via the elastic element.

7. The clipping device of claim 1 wherein the comb unit comprises a comb body and a setting arm to be mounted on the casing and/or cutting unit, the comb body and the setting arm being movable with respect to the cutting unit for changing the cut length.
